(19) United States
(12) Patent Application Publication
(10) Pub. No.: US 2026/0237995 A1
(43) Pub. Date: Aug. 13, 2026

(54) ELECTRONIC DEVICE WITH FAULT COMMUNICATION

(71) Applicant: STMicroelectronics International N.V., Geneva (CH)

(72) Inventors: Vanni Poletto, Milano (IT); Gianluca Tortora, Legnano (IT); Antonella Doretta Canobbio, Milano (IT); Antoine Pavlin, Puyricard (FR)

(21) Appl. No.: 19/048,580

(22) Filed: Feb. 7, 2025

(51) Int. Cl. H02H 3/20; H02H 1/00; H02H 5/04

(52) U.S. Cl. CPC H02H 3/207; H02H 1/0007; H02H 5/04

(57) ABSTRACT

An electronic device includes a first terminal, a second terminal, and a safety circuit coupled with the first terminal and the second terminal. The first terminal and the second terminal are couplable with a microcontroller. The safety circuit is configured to send internal fault information to and receive external fault information from the microcontroller through the first terminal at a first speed, control an on/off status of the electronic device based on detecting a fault, and communicate operational information with the microcontroller through the second terminal at a second speed less than the first speed.

### TECHNICAL FIELD

The present invention relates generally to electronic devices, and, in particular embodiments, to systems and methods for fault communication.

### BACKGROUND

Electronic devices often include various monitoring and control mechanisms to manage their operation. Such devices typically interface with external controllers or microprocessors that coordinate system-level functions. Communication between electronic devices and controllers can occur through various terminals or pins that allow exchange of signals and data.

In many applications, particularly in automotive and industrial environments, electronic devices operate in conditions where reliable control and monitoring are important considerations. Traditional communication interfaces between devices and controllers include serial peripheral interfaces (SPI), input/output pins, and dedicated signal lines. These communication paths allow controllers to send commands to electronic devices and receive status information regarding device operation.

Power management in electronic devices can involve multiple aspects of device control and monitoring. Electronic devices may transition between different operational states based on various conditions and requirements of the overall system. Conventional approaches for managing device states often employ dedicated hardware interfaces and standard communication protocols to facilitate interaction between system components.

### SUMMARY

In accordance with an embodiment, an electronic device includes: a first terminal and a second terminal, the first terminal and the second terminal being couplable with a microcontroller; and a safety circuit coupled with the first terminal and the second terminal, the safety circuit being configured to: send internal fault information to and receive external fault information from the microcontroller through the first terminal at a first speed; control an on/off status of the electronic device based on detecting a fault; and communicate operational information with the microcontroller through the second terminal at a second speed, the second speed being less than the first speed.

In accordance with another embodiment, an electronic device includes: a power driver; a digital core coupled with the power driver, the digital core further coupled with a microcontroller through a serial peripheral interface (SPI); and a bidirectional pad coupled with the power driver and the digital core, the bidirectional pad being configured to: receive an external fault signal from the microcontroller to disable the electronic device, and transmit an internal fault signal to the microcontroller indicating detected internal faults; and an activation latch coupled with the power driver, the digital core, and the bidirectional pad, the activation latch being configured to maintain a disabled state of the electronic device until receiving: a release of the external fault signal on the bidirectional pad, and an enable signal through the SPI.

In accordance with yet another embodiment, a method for fault handling includes: receiving a fault signal at a bidirectional pad of a device; setting a disable circuit to an error state, the disable circuit being coupled with the bidirectional pad; turning off a power driver with a latch, the latch being coupled with the disable circuit; and after clearing the error state in the disable circuit, turning on the power driver with the latch by sending a clear command from a serial peripheral interface to the latch.

It is to be understood that both the foregoing general description and the following detailed description are exemplary and explanatory only and are not restrictive of the disclosure, as claimed.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a diagram of a system implementing fault communication, in accordance with some embodiments;

FIG. 2 illustrates a diagram of another system implementing fault communication, in accordance with some embodiments; and

FIG. 3 illustrates a flow chart diagram of a method for fault handling, in accordance with some embodiments.

Corresponding numerals and symbols in the different figures generally refer to corresponding parts unless otherwise indicated. The figures are drawn to clearly illustrate the relevant aspects of the embodiments and are not necessarily drawn to scale. The edges of features drawn in the figures do not necessarily indicate the termination of the extent of the feature.

### DETAILED DESCRIPTION OF ILLUSTRATIVE EMBODIMENTS

The making and using of various embodiments are discussed in detail below. It should be appreciated, however, that the various embodiments described herein are applicable in a wide variety of specific contexts. The specific embodiments discussed are merely illustrative of specific ways to make and use various embodiments, and should not be construed in a limited scope.

Electronic devices commonly require mechanisms to detect internal faults and respond to external fault commands from system controllers. Traditional approaches implement these functions using separate dedicated terminals, such as one terminal for reporting internal faults to the controller and another terminal for receiving external fault commands. This increases pin count, circuit complexity, and board routing requirements. Additionally, conventional fault handling systems often lack clear priority between different control interfaces, potentially leading to conflicting commands during fault conditions.

In industrial and automotive applications where pin count directly impacts die size and cost, while reliable fault handling remains critical, there is a need for more efficient fault communication architectures. A particular challenge lies in maintaining robust bidirectional fault handling capabilities while minimizing the number of terminals required for implementation.

In case of fault occurrence inside an electronic device that is coupled with a microcontroller, it is desirable for the device to shut off and communicate the event to the microcontroller through an output terminal (e.g., a conductive output pad). It is further desirable for the microcontroller of the system to perform a fast emergency shutdown of the device using an input terminal (e.g., a conductive output pad) in case of a system failure detection. The switch from an active state to an off state desirably should have higher priority than an automatic shutdown of the device due to an internal failure. Therefore it is desirable for the device and the microcontroller to be informed of a shutdown with a fast communication (e.g., on the order of nanoseconds) in both directions between the device and the microcontroller.

In various embodiments, a bidirectional communication mechanism allows both transmission of internal fault conditions to an external controller and receipt of external fault commands through a single terminal. This approach reduces pin count while maintaining robust fault handling capabilities. The terminal can operate with priority over other communication interfaces, ensuring reliable shutdown capability when needed. This bidirectional communication mechanism provides a fast emergency disable path from the microcontroller to the device and a fast communication of an internal device fault from the device to the microcontroller across the same path. This path is fast (e.g., on the order of nanoseconds) because the disable command is not processed by digital logic (e.g., in a digital logic block of the device) or through a serial peripheral interface (SPI), and the path is bidirectional because both parties (in other words, the microcontroller and the device) are updated immediately on the halt condition of the other party.

In various embodiments, an electronic device includes a bidirectional pad coupled to a controller (e.g., a microcontroller). The bidirectional pad transmits internal fault conditions detected by the device to the controller and receives external fault commands from the controller. A switchable pull-up resistor maintains the logic state of the pad. When either an internal fault occurs or an external fault command is received, the device latches into a disabled state. The device remains disabled until both the fault condition is cleared from the bidirectional pad and a separate enable command is received through another interface.

In one or more embodiments, a safety circuit (also referred to as a Safety Management Unit (SMU)) within the device monitors various operating parameters such as voltage levels and temperature. Upon detecting a fault condition, the safety circuit pulls the bidirectional pad to a fault state and disables power circuitry within the device. Similarly, when the controller detects a system-level fault condition, it can force the bidirectional pad to the fault state, which also results in disabling the power circuitry of the device. This dual-purpose fault handling through a single terminal provides efficient fault management while minimizing terminal count.

The device employs a two-step re-enablement process requiring both release of any fault condition on the bidirectional pad and receipt of an enable command through a separate interface such as SPI. This multi-step approach prevents inadvertent re-enablement while maintaining reliable control over device operation. The fault indication of the bidirectional pad takes priority over other control interfaces, ensuring that fault conditions reliably disable the device regardless of other system states or commands.

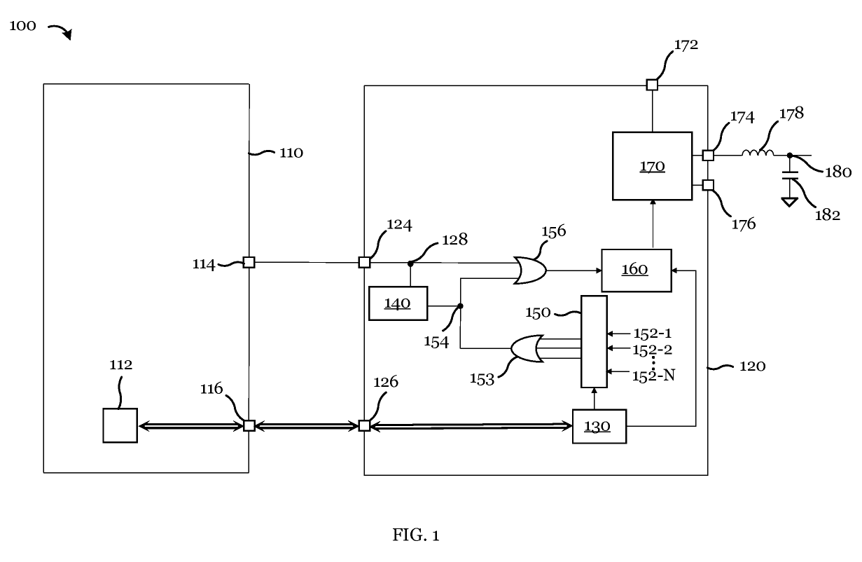

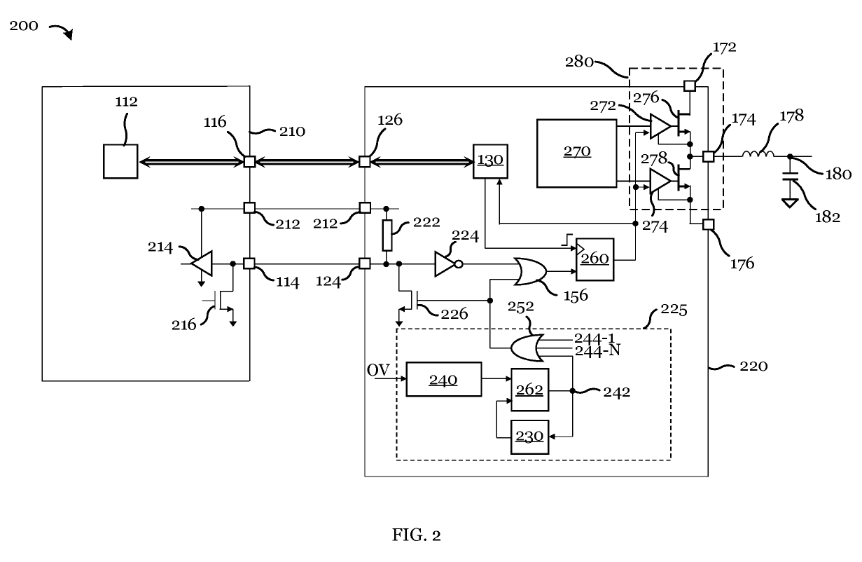

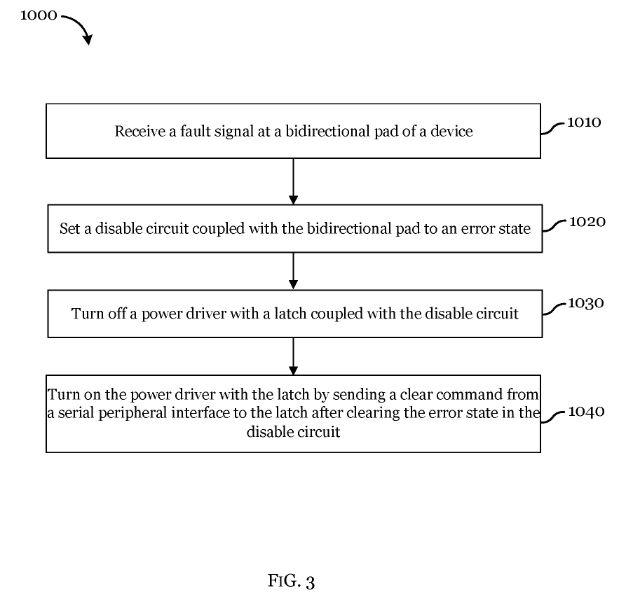

Embodiments of the disclosure are described in the context of the accompanying drawings. An embodiment of a system implementing fault communication between a microcontroller and an electronic device will be described using FIG. 1. Another embodiment of a system implementing fault communication between a microcontroller and an electronic device with filtering capabilities will be described using FIG. 2. An embodiment of a method for fault handling will be described using FIG. 3.

FIG. 1 illustrates a system 100 according to various embodiments that implements fault communication between a microcontroller 110 and an electronic device 120 using a reduced number of terminals. In various embodiments, the system 100 provides bidirectional fault handling through a single terminal while maintaining reliable shutdown capabilities and clear control priorities. The system 100 enables both transmission of internal fault conditions from the device to the microcontroller and receipt of external fault commands from the microcontroller through the same terminal, while using a separate terminal for operational control. This architecture reduces pin count compared to traditional approaches that use separate dedicated terminals for fault input and output.

The system 100 includes a microcontroller 110 that controls and monitors a device 120, where the device 120 can be disabled either by internal fault conditions or by external commands from the microcontroller 110, with the fault handling taking priority over other control interfaces. The microcontroller 110 provides control and monitoring functionality for the system 100. In one or more embodiments, the microcontroller 110 includes a serial peripheral interface (SPI) 112 that enables communication of commands and status information with the device 120, such as through a standard serial protocol.

Terminals of the microcontroller 110 and the electronic device 120 provide external couplings for data and/or power connection. In various embodiments, the terminals are conductive pads that provide electrically accessible input and output (IO) for chips; for example, ground and supply voltages and various input and output signals may be coupled through the pads. However, the terminals may be pins or any other suitable feature.

Terminal 114 of the microcontroller 110 serves as a bidirectional fault terminal (also referred to as a bidirectional pad) that both receives fault status information from the device 120 and transmits external fault commands to the device 120. Terminal 116 provides a separate communication path for operational control signals that have lower priority than fault-related signals. In various embodiments, the microcontroller 110 uses terminal 114 to immediately disable the device 120 upon detecting external fault conditions, while using terminal 116 for normal operational control when no faults are present. The SPI 112 enables the microcontroller 110 to send commands for clearing faults and re-enabling the device 120 after fault conditions have been resolved.

The device 120 includes multiple interfaces and circuits that work together to provide reliable fault handling and power control functionality. In one or more embodiments, terminals 124 and 126 of the device 120 connect to respective terminals 114 and 116 of the microcontroller 110, where terminal 124 serves as a bidirectional fault communication terminal and terminal 126 receives operational control signals. An SPI 130 enables reception of commands from the microcontroller 110 for functions such as fault clearing and device enabling. In various embodiments, the terminal 124 enables bidirectional fault communication with the microcontroller 110 (or any other coupled device) operating at a speed in a range of tenths of nanoseconds to microseconds because it involves a signal transition between only a few logic ports that works as an interrupt signal to both microcontroller 110 and device 120, as it may not involve any planned interaction through SPI 112 and SPI 130. The terminal 126 enables communication of operational control signals at a speed in a range of up to milliseconds as this involves the internal operation time of the microcontroller 110, and includes its monitoring strategy of device 120, the packaging of the SPI frame inside SPI 112, the communication to SPI 130 and the decoding of, for example, a frame inside SPI 130. As such, the operational information is exchanged at a slower speed than the fault information due to the operational information being exchanged between SPI 112 and SPI 130, while the fault information is exchanged without being processed by a logic block or circuit or through the SPIs.

The fault communication between terminal 124 and terminal 114 is bidirectional due to allowing both the device 120 and the microcontroller 110 to be updated on the halt condition of the other respective device across the coupling. This fast fault communication is advantageous because its speed (e.g., on the order of nanoseconds) is beneficial for achieving device shutdown before a fault can cause serious device damage, while the relatively slower communication of operational information (such as between SPI 112 and SPI 130 on the order of milliseconds) is beneficial for exchanging more complex information that has a lower priority for speed than immediate fault information.

The device 120 includes a disable circuit 140 that processes fault conditions and controls device shutdown. In some embodiments, the disable circuit 140 is coupled to the terminal 124 through a node 128 and to a fault register 150 through an OR gate 153 and a node 154. The disable circuit 140 sets a value indicating an error state if it receives a signal indicating a fault from the fault register 150, and the disable circuit 140 can then share the value indicating the error state with the microcontroller 110 through the terminal 114.

A fault register 150 receives and stores multiple fault inputs 152-1, 152-2 through 152-N representing some various fault conditions 1 to N that may occur within the device 120. These fault inputs may include, but are not limited to, overvoltage conditions, undervoltage conditions, and over-temperature conditions. In an example, the fault inputs 152-1, 152-2 through 152-N are coupled to one or more safety circuits within the device 120 monitoring various operating parameters such as voltage levels and temperature. The fault register 150 is coupled through an OR gate 153 to node 154, allowing any active internal fault to trigger a shutdown of the device 120 through the disable circuit 140.

A latch 160 (also referred to as an activation latch) maintains the operational state of the device 120 (in other words, the on/off status of the device 120) by coupling with a power stage 170 and provides shutdown memory. The latch 160 is coupled through an OR gate 156 to the node 128 to receive an external signal indicating a fault from the microcontroller 110 and to the node 154 to receive an internal fault signal from one of the fault inputs 152-1, 152-2 through 152-N. In various embodiments, the latch 160 requires both clearance of any fault conditions from the OR gate 156 and receipt of an enable command through the SPI 130 before allowing the device 120 to resume operation. This two-step re-enabling process prevents inadvertent reactivation of the device 120 after a fault condition.

The power stage 170 represents the main power processing section of the device 120. In various embodiments, the power stage 170 is a half bridge power driver. However, any suitable architecture may be used for the power stage 170. In one or more embodiments, the power stage 170 includes a high voltage terminal 172 for receiving input power, a switch terminal 174 for controlling power flow, and a ground terminal 176 for providing a reference potential. An inductor 178 couples between switch terminal 174 and node 180 for energy storage and power conversion, and a capacitor 182 is coupled between node 180 and ground to provide output filtering and energy storage. The power stage 170 can be immediately disabled by the latch 160 after receiving either internal fault conditions through the fault register 150 or external commands received through terminal 124.

In various embodiments, the system 100 implements bidirectional fault communication and control through a single terminal while maintaining reliable shutdown capabilities. When a fault occurs, whether originating from the microcontroller 110 or internally within device 120, the fault condition triggers a shutdown sequence through OR gate 156.

If the fault originates from the microcontroller 110, the microcontroller 110 sets terminal 114 to a state indicating an error condition. This error state is communicated through terminal 124 of device 120 to the latch 160. In response to detecting the error state on terminal 124, the disable circuit 140 triggers latch 160 to disable power stage 170.

Alternatively, if a fault originates internally within device 120, one or more of the fault inputs 152-1 through 152-N become active. The active fault is stored in fault register 150 and propagated through OR gate 156 to node 154. The disable circuit 140 then drives terminal 124 to the error state to communicate the fault condition to microcontroller 110.Simultaneously, the OR gate 156 triggers the latch 160 to disable power stage 170.

Once terminal 124 enters the error state and latch 160 disables power stage 170, the device 120 remains disabled even if terminal 124 returns to a normal state. To reactivate power stage 170, the system 100 requires a two-step process: first, any error state on terminal 124 must be cleared so that the disable circuit 140 is set to indicate a normal state, and second, an enable command must be received through SPI 130 to set latch 160.

In various embodiments, when an internal fault condition clears, the corresponding fault input 152-1 through 152-N returns to an inactive state. However, fault register 150 maintains the fault status until explicitly cleared. To clear a stored fault in fault register 150, the microcontroller 110 sends a clear command through SPI 112, which propagates through SPI 130 to reset fault register 150. This returns the disable circuit 140 to its normal state, allowing the two-step reactivation process to proceed.

The system 100 prioritizes fault handling over normal operation by implementing direct hardware paths for fault signaling through terminal 124 while requiring software intervention through SPIs 112 and 130 for fault clearing and device re-enabling. This architecture ensures reliable shutdown capability while minimizing terminal count through bidirectional communication on terminal 124.

FIG. 2 illustrates a system 200 according to various embodiments that implements fault handling with filtering capabilities. Similar to system 100, system 200 includes a microcontroller 210 communicating with a device 220 through bidirectional fault communication. As is described above with respect to FIG. 1, the SPI 112 of the microcontroller 210 is coupled with the SPI 130 of the device 220 through respective terminals 116 and 126 in order to send commands for clearing faults and re-enabling the device 220 after fault conditions have been resolved.

In one or more embodiments, system 200 provides enhanced noise immunity and fault verification through additional filtering and control circuitry. The microcontroller 210 and the device 220 comprise terminals 212, which provide a supply voltage V DD that allows a supply voltage compatibility between the microcontroller 210 and the device 220. The supply voltage V DD is the output interface supply of the microcontroller 210 that is connected to the input interface of the device 220 to ensure communication compatibility of the terminals 114 and 124 that handle the fault condition. As an example of a possible circuit layout in the microcontroller 210, terminal 212 of the microcontroller 210 provides the supply voltage V DD to an amplifier 214 which amplifies fault signals received through terminal 114, and fault signals from within the microcontroller 210 may pass to the device 220 through a transistor 216 coupled with the terminal 114 to provide controlled fault signaling.

The device 220 includes a digital core 225 that manages internal operations. In some embodiments, the digital core 225 includes one or more components of the SPI 130. For example, the register 230 and the multiplexer 262 may be parts of the SPI 130. A filter circuit 240 of the digital core 225 provides noise filtering and signal conditioning for fault signals received through terminal 124. The filter circuit 240 and associated digital control logic implement an overvoltage (OV) threshold detection with hysteresis for reliable fault detection. While OV threshold detection is included as an example in the embodiments illustrated by FIG. 2, other inputs may be present in parallel to this one, such as undervoltage and overtemperature fault conditions, and all such combinations of inputs are within the scope of the disclosed embodiments. This filtered approach prevents false triggering from noise or voltage transients while maintaining fast response to valid fault conditions. The status of both filtered and unfiltered fault signals can be monitored through digital core 225 and reported back to microcontroller 210 via SPI 130 for diagnostic purposes. The filter circuit 240 provides output through a multiplexer 262 to set an OV status bit 242. A register 230 (for example, one of the registers of the SPI 130) is coupled to the OV status bit 242 and a reset signal can be sent from the register 230 through the multiplexer 262 to clear the OV status bit 242 once the OV fault is cleared. In various embodiments, the digital core 225 further includes an OR gate 252 that combines multiple fault sources 244-1 to 244-N as well as the OV status bit 242.

The digital core 225 further provides an output signal from the OR gate 252 through another OR gate 156 to a latch 260 that maintains the operational state of device 220 and requires specific sequences for re-enabling after a fault condition. The OR gate 156 further receives an external fault signal through an inverter 224 from a pull-up network formed by transistor 226 and resistor 222. In various embodiments, the resistor 222 has a resistance in a range of 5 KΩ to 50 KΩ, such as 10 KΩ. The resistor 222 is coupled between the terminal 124 and a terminal 212 that provides the supply voltage V DD. The inverter 224 may provide signal conditioning.

A digital controller 270 coordinates operation of a power driver 280. As illustrated by FIG. 2, the power driver 280 is a half bridge power driver. However, the power driver 280 may have any suitable architecture. The digital controller 270 interfaces with the components of the power driver 280 such as amplifiers 272, 274 and transistors 276, 278 to control power stage operation based on fault conditions and operational commands.

This arrangement provides multiple layers of control while maintaining fast fault response through the dedicated fault path between terminal 124 and terminal 114. Through this architecture, system 200 achieves reliable fault handling with enhanced noise immunity compared to system 100, while maintaining the benefits of bidirectional communication through a single terminal. The filtered fault detection path ensures robust operation in noisy environments while preserving fast shutdown capability for valid fault conditions.

In various embodiments, system 200 implements multiple fault handling scenarios through coordinated operation of its components. When a fault occurs within device 220, the fault condition triggers an immediate shutdown sequence while simultaneously communicating the fault to microcontroller 210 through an independent fast path, such as from the digital core 225 through the transistor 226 to terminal 124 and thence to terminal 114 of the microcontroller 210.

During a fault occurrence, the device 220 latches off its power driver 280 through digital controller 270 and associated control circuitry including amplifiers 272, 274 and transistors 276, 278. Simultaneously, terminal 124 is pulled low through the fault communication path from the OR gate 252 of the digital core 225 and through the transistor 226 to inform microcontroller 210 of the fault condition. This fast path operates independently of the SPI 130, providing immediate fault communication without processing delays.

When the fault condition disappears, device 220 maintains its latched-off state through latch 260 until explicitly re-enabled. The fault disappearance allows terminal 124 to return high through the pull-up network formed by transistor 226 and resistor 222, informing microcontroller 210 that the fault condition has cleared. However, the digital controller 270 maintains the power driver 280 in its disabled state until receiving a specific re-enable command through SPI 130.

In various embodiments, microcontroller 210 can initiate a safe shutdown by actively pulling terminal 124 low through transistor 216. The independent fast path through terminal 124 ensures immediate fault communication in both directions, while the slower path from SPI 130 to SPI 112 and vice versa enables detailed fault diagnosis and controlled device re-enabling after fault conditions clear.

In various embodiments, system 200 implements a comprehensive fault handling architecture comprising several key elements that work together to ensure reliable operation. The bidirectional terminal 124 serves as the primary fault communication interface between microcontroller 210 and device 220, capable of both receiving external fault signals and transmitting internal fault status.

The SPI 130 provides a secondary communication path that enables direct control of read/write operations for status monitoring and device enabling. While this interface allows for detailed control and diagnostics, it operates as a "slow" communication path compared to the fault handling through terminal 124. For example, with an SPI clock of 1MHz, commands through SPI 130 may request at least 30 microseconds for transmission, whereas fault signaling through terminal 124 occurs nearly instantaneously (e.g., over a duration in a range of tenths of nanoseconds to microseconds).

The digital core 225 serves as a Safety Management Unit (SMU) (also referred to as a safety circuit) that monitors, processes, and reports failure events. The digital core 225 generates a global fault signal that feeds into OR gate 252 and can force output signals on terminal 124 through the associated control circuitry. In various embodiments, multiple fault conditions monitored by digital core 225 may include overvoltage, undervoltage, and other threshold violations, with filter circuit 240 providing timing control to prevent oscillation.

The latch 260 directly controls the on/off status of the device 220 through digital controller 270 and its associated power driver 280 comprising amplifiers 272, 274 and transistors 276, 278. The logic implemented through these components responds to fault conditions received through terminal 124 while maintaining proper sequencing for device enabling and disabling.

A switchable pull-up network, formed by transistor 226 and resistor 222, provides controlled bias for terminal 124. The terminal 124 is coupled between the switching element (transistor 226) and resistor 222, with inverter 224 providing signal conditioning. In various embodiments, closure of any fault switch, whether triggered by an internal fault through digital core 225 or an external fault from microcontroller 210, pulls terminal 124 to a logic low state indicating a fault condition.

In various embodiments, system 200 implements a defined sequence of operations for startup, normal operation, and fault handling. When power is initially applied, device 220 boots into a "wait" mode that operates with minimal current consumption as a failsafe default state. During this initial state, digital controller 270 maintains the power driver 280 in a disabled condition through its control of amplifiers 272, 274 and transistors 276, 278.

To initiate normal operation, microcontroller 210 first releases its control over terminal 124, allowing the pull-up network of transistor 226 and resistor 222 to establish a normal operating state. Following this, microcontroller 210 uses SPI 130 to acknowledge and clear any existing fault conditions stored within the latch 260. Fault conditions stored within the digital core 225 may also be cleared by the SPI 130 through, for example, clearing the register 230 that is part of the SPI 130. After fault clearance, the internal pulldown function implemented through the fault detection circuitry releases its control of terminal 124. This two-step sequence ensures proper initialization of the fault detection system.

The final step in enabling device 220 involves microcontroller 210 setting the latch 260 through a command sent via SPI 130. After completing this entire sequence the device 220 enter its normal operating state, with digital controller 270 enabling normal operation of the power driver 280 including amplifiers 272, 274 and transistors 276, 278.

During normal operation, two types of events can trigger a fault response: internal failures detected by digital core 225 (such as overvoltage, undervoltage, or over-temperature conditions) or external emergency requests from microcontroller 210 through terminal 124. These fault sources combine in an OR configuration through OR gate 156, ensuring that either type of fault triggers the shutdown sequence.

In various embodiments, either type of fault condition resets latch 260 through a fast path that bypasses the normal digital control paths. This direct hardware connection ensures immediate response to fault conditions without software processing delays, such as in SPIs. The fast path operates independently of both digital core 225 and SPI 130, providing reliable shutdown capability even if these blocks experience operational issues.

This architecture ensures fail-safe operation by requiring explicit sequences for enabling while maintaining fast, hardware-based paths for fault detection and shutdown. The combination of careful initialization requirements and rapid fault response provides robust protection while maintaining system flexibility through the SPI 130.

The disclosed embodiments provide several significant advantages over conventional approaches to fault handling and device control. In various embodiments, system 200 enables asynchronous device shutdown through a single bidirectional terminal 124, allowing microcontroller 210 to force an immediate shutdown at any time without relying on software processing or communication protocols. This direct hardware path ensures reliable safety response regardless of system state or software conditions.

The architecture implements a robust startup protection scheme wherein device 220 cannot be activated until microcontroller 210 explicitly releases control of terminal 124. This requirement prevents inadvertent device activation during system initialization or power fluctuations. Furthermore, the system mandates a two-step activation sequence requiring both release of terminal 124 and a separate enable command through SPI 130, providing an additional layer of startup safety.

In various embodiments, the use of a single bidirectional terminal 124 for both fault status monitoring and shutdown control optimizes terminal usage while maintaining full fault handling capability. This reduction in terminal count can directly impact die size and cost while simplifying board layout and reducing system complexity. The bidirectional communication allows both components to maintain awareness of system fault status through a single electrical coupling.

The system enables a user (e.g., a user operating a microcontroller coupled with the device) to initiate device shutdown for any reason through terminal 124, not just in response to fault conditions. This flexibility allows system-level safety decisions to use the same fast shutdown path as device-level faults. The immediate propagation of shutdown commands through the hardware path of terminal 124 ensures consistent and rapid response regardless of the shutdown trigger.

In various embodiments, the architecture provides extensive adaptability to different applications while maintaining a consistent fault handling framework. Digital core 225 can be configured to monitor different fault conditions and thresholds, while maintaining the same fast shutdown path through terminal 124. Filter circuit 240 can be adjusted to accommodate different noise environments and response time requirements without compromising the basic safety architecture.

These advantages combine to create a fault handling system that reduces complexity and component count while improving reliability and response time compared to traditional approaches using separate fault input and output terminals. The architecture ensures fail-safe operation while providing flexibility for different applications and operating requirements.

FIG. 3 illustrates a process flow chart diagram of a method 1000 for fault handling, in accordance with some embodiments. In step 1010, a fault signal is received at a bidirectional pad of a device, as described above with respect to FIG. 1. In step 1020, a disable circuit is set to an error state, as described above with respect to FIG. 1. The disable circuit is coupled with the bidirectional pad.

In step 1030, a power driver is turned off with a latch, as described above with respect to FIG. 1. The latch is coupled with the disable circuit. In step 1040, the power driver is turned on with the latch by sending a clear command from a serial peripheral interface to the latch after clearing the error state in the disable circuit, as described above with respect to FIG. 1.

In various embodiments, a bidirectional communication mechanism allows both transmission of internal fault conditions to an external controller and receipt of external fault commands through a single terminal. In power DC-DC applications, this architecture enables a microcontroller to continuously monitor failure events that may occur during device operation while maintaining ability to shut down the device at any time. The microcontroller can initiate shutdown due to external events that may or may not correlate with the internal state of the device. Rather than implementing separate terminals for fault monitoring and shutdown control, the bidirectional communication provides both functions through a single terminal while maintaining rapid response times through direct hardware paths. This approach reduces terminal count and system complexity while ensuring reliable fault handling and shutdown capability through prioritized hardware control paths that operate independently of software processing.

Example embodiments of the disclosure are summarized here. Other embodiments can also be understood from the entirety of the specification as well as the claims filed herein.

Example 1. An electronic device including: a first terminal and a second terminal, the first terminal and the second terminal being couplable with a microcontroller; and a safety circuit coupled with the first terminal and the second terminal, the safety circuit being configured to: send internal fault information to and receive external fault information from the microcontroller through the first terminal at a first speed; control an on/off status of the electronic device based on detecting a fault; and communicate operational information with the microcontroller through the second terminal at a second speed, the second speed being less than the first speed.

Example 2. The electronic device of example 1, where the first terminal is a bidirectional pad.

Example 3. The electronic device of one of examples 1 or 2, where controlling the on/off status includes controlling an activation latch coupled with a power stage.

Example 4. The electronic device of example 3, where the power stage includes a half bridge power driver.

Example 5. The electronic device of one of examples 3 or 4, where the activation latch is coupled with the first terminal through a pull-up network.

Example 6. The electronic device of one of examples 1 to 5, where the internal fault information includes an overvoltage condition.

Example 7. The electronic device of one of examples 1 to 6, where the internal fault information includes an undervoltage condition.

Example 8. The electronic device of one of examples 1 to 7, where the internal fault information includes an over-temperature condition.

Example 9. An electronic device including: a power driver; a digital core coupled with the power driver, the digital core further coupled with a microcontroller through a serial peripheral interface (SPI); and a bidirectional pad coupled with the power driver and the digital core, the bidirectional pad being configured to: receive an external fault signal from the microcontroller to disable the electronic device, and transmit an internal fault signal to the microcontroller indicating detected internal faults; and an activation latch coupled with the power driver, the digital core, and the bidirectional pad, the activation latch being configured to maintain a disabled state of the electronic device until receiving: a release of the external fault signal on the bidirectional pad, and an enable signal through the SPI.

Example 10. The electronic device of example 9, where the bidirectional pad has priority over the coupling between the SPI and the microcontroller.

Example 11. The electronic device of one of examples 9 or 10, where the activation latch is coupled to the bidirectional pad through a pull-up network.

Example 12. The electronic device of example 11, where the pull-up network includes a resistor coupled between the bidirectional pad and a supply voltage terminal.

Example 13. The electronic device of one of examples 11 or 12, where the pull-up network includes a transistor coupled between the bidirectional pad and an output of the digital core.

Example 14. The electronic device of one of examples 9 to 13, where the digital core includes a filter circuit configured to implement an OV threshold detection with hysteresis.

Example15. The electronic device one of examples 9 to 14, where the digital core includes a multiplexer, a OV status bit, and a register of the SPI configured to send a reset signal through the multiplexer to clear the OV status bit once an OV fault is cleared.

Example16. The electronic device of example 15, where the digital core further includes an OR gate coupled with the OV status bit and a plurality of fault inputs, the OR gate being configured to provide the internal fault signal.

Example 17. A method for fault handling, the method including: receiving a fault signal at a bidirectional pad of a device; setting a disable circuit to an error state, the disable circuit being coupled with the bidirectional pad; turning off a power driver with a latch, the latch being coupled with the disable circuit; and after clearing the error state in the disable circuit, turning on the power driver with the latch by sending a clear command from a serial peripheral interface to the latch.

Example 18. The method of example 17, where the fault signal is received from a microcontroller coupled to the bidirectional pad.

Example 19. The method of example 17, where the fault signal is received from a digital core of the device.

Example 20. The method of one of examples 17 to 19, where the clear command is received from a microcontroller coupled to the serial peripheral interface along a separate path from a coupling of the microcontroller with the bidirectional pad.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. An electronic device comprising:
a first terminal and a second terminal, the first terminal and the second terminal being couplable with a microcontroller; and
a safety circuit coupled with the first terminal and the second terminal, the safety circuit being configured to:
send internal fault information to and receive external fault information from the microcontroller through the first terminal at a first speed;
control an on/off status of the electronic device based on detecting a fault; and
communicate operational information with the microcontroller through the second terminal at a second speed, the second speed being less than the first speed.

2. The electronic device of claim 1, wherein the first terminal is a bidirectional pad.

3. The electronic device of claim 1, wherein controlling the on/off status comprises controlling an activation latch coupled with a power stage.

4. The electronic device of claim 3, wherein the power stage comprises a half bridge power driver.

5. The electronic device of claim 3, wherein the activation latch is coupled with the first terminal through a pull-up network.

6. The electronic device of claim 1, wherein the internal fault information comprises an overvoltage condition.

7. The electronic device of claim 1, wherein the internal fault information comprises an undervoltage condition.

8. The electronic device of claim 1, wherein the internal fault information comprises an over-temperature condition.

9. An electronic device comprising:
a power driver;
a digital core coupled with the power driver, the digital core further coupled with a microcontroller through a serial peripheral interface (SPI); and
a bidirectional pad coupled with the power driver and the digital core, the bidirectional pad being configured to:
receive an external fault signal from the microcontroller to disable the electronic device, and
transmit an internal fault signal to the microcontroller indicating detected internal faults; and
an activation latch coupled with the power driver, the digital core, and the bidirectional pad, the activation latch being configured to maintain a disabled state of the electronic device until receiving:
a release of the external fault signal on the bidirectional pad, and
an enable signal through the SPI.

10. The electronic device of claim 9, wherein the bidirectional pad has priority over the coupling between the SPI and the microcontroller.

11. The electronic device of claim 9, wherein the activation latch is coupled to the bidirectional pad through a pull-up network.

12. The electronic device of claim 11, wherein the pull-up network comprises a resistor coupled between the bidirectional pad and a supply voltage terminal.

13. The electronic device of claim 11, wherein the pull-up network comprises a transistor coupled between the bidirectional pad and an output of the digital core.

14. The electronic device of claim 9, wherein the digital core comprises a filter circuit configured to implement an OV threshold detection with hysteresis.

15. The electronic device of claim 9, wherein the digital core comprises a multiplexer, a OV status bit, and a register of the SPI configured to send a reset signal through the multiplexer to clear the OV status bit once an OV fault is cleared.

16. The electronic device of claim 15, wherein the digital core further comprises an OR gate coupled with the OV status bit and a plurality of fault inputs, the OR gate being configured to provide the internal fault signal.

17. A method for fault handling, the method comprising:
receiving a fault signal at a bidirectional pad of a device;
setting a disable circuit to an error state, the disable circuit being coupled with the bidirectional pad;
turning off a power driver with a latch, the latch being coupled with the disable circuit; and
after clearing the error state in the disable circuit, turning on the power driver with the latch by sending a clear command from a serial peripheral interface to the latch.

18. The method of claim 17, wherein the fault signal is received from a microcontroller coupled to the bidirectional pad.

19. The method of claim 17, wherein the fault signal is received from a digital core of the device.

20. The method of claim 17, wherein the clear command is received from a microcontroller coupled to the serial peripheral interface along a separate path from a coupling of the microcontroller with the bidirectional pad.
